(19) United States
(12) Patent Application Publication
(10) Pub. No.: US 2026/0217913 A1
(43) Pub. Date: Jul. 30, 2026

(54) SEMI-AROMATIC POLYAMIDES WITH A LOW MELTING TEMPERATURE

(71) Applicant: SYENSQO SPECIALTY POLYMERS USA, LLC, Alpharetta, GA (US)

(72) Inventors: Joel Flores, Anaheim, CA (US); Stéphane Jeol, Saint-Fons (FR); Ryan Mondschein, Cumming, GA (US); Peter Mushenheim, Atlanta, GA (US); Lewis Karl Williams, Cumming, GA (US)

(73) Assignee: SYENSQO SPECIALTY POLYMERS USA, LLC, Alpharetta, GA (US)

(21) Appl. No.: 19/135,043

(22) PCT Filed: Nov. 30, 2023
(86) PCT No.: PCT/EP2023/083800

§ 371 Date: Jun. 2, 2025

Related U.S. Application Data
(60) Provisional application No. 63/385,648, filed on Dec. 1, 2022.

(30) Foreign Application Priority Data
Jan. 31, 2023 (EP) 23154138.4

(51) Int. Cl. C08G 69/26; C08G 69/28; C08L 69/00

(52) U.S. Cl. CPC C08G 69/265; C08G 69/28; C08L 69/00

(57) ABSTRACT

The invention relates to a polyamide (PA) exhibiting a melting temperature Tm strictly lower than 290° C. and comprising recurrings units formed from the polycondensation of a diamine component (A) and a dicarboxylic acid component (B) wherein: a) the diamine component (A) comprises: —between 38.0 and 54.0 mol % of 1,6-diaminohexane; —between 15.0 and 40.0 mol % of a diamine selected in the group consisting of 1,9-diaminononane, 1,10-diaminodecane and a combination of said two diamines; —between 15.0 and 40.0 mol % of a diamine selected in the group consisting of 1,3-bis(aminomethyl)cyclohexane, 1,4-bis(aminomethyl)cyclohexane and a combination of said two diamines; these proportions in mol % being based on the total amount of diamines in the diamine component (A); b) the dicarboxylic acid component (B) comprises: —between 95.0 and 100.0 mol % of terephthalic acid; —between 0 and 5.0 mol % of another diacid selected in the group consisting of isophthalic acid, adipic acid and a combination of the two said diacids; these proportions in mol % being based on the total amount of diacids in the dicarboxylic acid component (B).

This application claims priority of U.S. patent application No. 63/385,648 filed on 1 Dec. 2022 and European patent application No. 23154138.4 filed on 31 Jan. 2023, the content of which being entirely incorporated herein by reference for all purposes. In case of any incoherency between this application and the two US & EP applications that would affect the clarity of a term or expression, it should be made reference to the present application only.

### FIELD OF THE INVENTION

The invention relates to a semi-crystalline semi-aromatic copolyamide having a high glass transition temperature and a low melting temperature along with a combination of other properties that makes it suitable for the preparation of a thermoplastic composite.

### BACKGROUND OF THE INVENTION

Aliphatic polyamides such as the very well-known PA6 and PA66 are a class of thermoplastic resins much appreciated as they are easy to process and generally have high melting points. They also exhibit high heat resistance values, in particular when reinforced with fibers or fillers. However, they typically have high water absorption values of up to 10% when stored in water.

The aliphatic polyamides cannot be used for many applications with stringent requirements placed on dimensional stability which also apply to wet or moist conditions. It is not only dimensions that alter with water absorption but also mechanical properties. Water absorption reduces stiffness and strength to a fraction of their original values. There are however many applications involving mechanical load in contact with water or ambient moisture.

Semi-aromatic polyamides have been developed to address these problems. Trogamid T5000 is a commercial amorphous polyamide composed of terephthalic acid and of a mixture of 2,2,4-TMD and 2,4,4-TMD. This polyamide, amorphous in nature, features high mechanical strength and high toughness. However, it loses all of its mechanical integrity when exposed to temperatures higher than its Tg=150° C. (dry state) and in presence of water due to a high moisture absorption around 7.5 wt. %.

WO 2018/234439 discloses a polyamide BACT/10T/6T without any specific composition.

WO 2018/172717 discloses semi-aromatic copolyamides with 1.3 BAC. The polyamides with 1.3 BAC disclosed exhibit a Tm higher than 290° C. or are based on different compositions with a higher proportion of BACT.

WO 2018/172718 discloses semi-aromatic copolyamides with 1.3 BAC. The polyamides with 1.3 BAC disclosed exhibit a Tm higher than 290° C. or are based on different compositions.

US 2008/274355 (D1) discloses a polyamide molding composition based on a copolyamide 10T/6T having from 40 to 95 mol % of 10T units and from 5 to 60 mol % of 6T units.

US 2019/338074 and WO 2018/011495/US 2018/251601 (D2) disclose semi-aromatic copolyamides with a melting temperature lower than 300° C. based on 1.3 BAC. The copolyamides of D2 preferably exhibit a Tm−Tc (Tm=melting temperature; Tc=crystallization temperature)<40° C. The two compositions based on 10T, 6T and BACT disclosed in the experimental section of US 2019/338074 and WO 2018/011495 are not according to the composition of claim 1. D2 disclose more specifically the copolyamides 10T/BACT/6T which exhibit a low (Tm−Tc) value lower than 37° C. and a heat of fusion Hm higher than 40.0 J/g.

| 10T | BACT | 6T | Tm | Tg | Tm − Tc | Hm |
|---|---|---|---|---|---|---|
| (mol %) | | | (° C.) | | | (J/g) |
| 42.5 | 51.9 | 5.5 | 270.9 | 161.3 | 36.9 | 49.7 |
| 40.5 | 49.5 | 10 | 263.9 | 143.2 | 30.7 | 44.5 |

US 2016/0152770 discloses a semi-aromatic copolyamide comprising, in copolymerized form: a) 36 to 50 mol % of terephthalic acid, b) 0 to 14 mol % of isophthalic acid, c) 35 to 42.5 mol % of hexamethylene diamine, d) 7.5 to 15 mol % of at least one cyclic diamine, where the cyclic diamine d) comprises isophoronediamine. The proportion of hexamethylene diamine is higher than in claim 1. Moreover, there is no mention of bis(aminomethyl)cyclohexane.

US 2017/0107326 discloses polyamides with a proportion of 1,6-hexamethylene diamine and a melting temperature higher than in claim 1.

WO 2021/037850 discloses a polyamide formed from a diamine component (A) comprising 55 mol % to 75 mol % of a C₄-C₈ aliphatic diamine, 25 mol % to 45 mol % of a C₉-C₁₂ aliphatic diamine and 0 mol % to 10 mol % of a cycloaliphatic diamine containing a cyclohexyl group and a dicarboxylic acid component (B) comprising: 90 mol % to 100 mol % of terephthalic acid, 0 mol % to 10 mol % of a C₆-C₁₈ aliphatic dicarboxylic acid or a C₈-C₁₈ aromatic dicarboxylic acid distinct from terephthalic acid, and 0 mol % to 10 mol % of a cycloaliphatic dicarboxylic acid containing a cyclohexyl group. The proportion of C₄-C₈ aliphatic diamine is higher than the proportion of hexamethylene diamine of claim 1.

WO 2021/224431 discloses a polyamide derived from the polycondensation of monomers in a reaction mixture comprising: a diamine component (A) comprising 20 mol % to 95 mol % of a C₄ to C₁₂ aliphatic diamine and 5 mol % to 80 mol % of bis(aminoalkyl)cyclohexane and a dicarboxylic acid component (B) comprising 30 mol % to 100 mol % of terephthalic acid and 0 mol % to 70 mol % of a cyclohexanedicarboxylic acid. WO 2021/224431 more particularly discloses a polyamide 6,T/1,3-BAC,T/6,CHDA/1,3-BAC, CHDA with a Tm of 330° C.

WO 2022/180195 discloses a polyamide prepared from a diamine component comprising from 55 to 75 mol % of a C₄-C₈ diamine from 25 to 45 mol. % of a C₉ to C₁₂ aliphatic diamine; and 0 to 10 mol % of a cycloaliphatic diamine containing a cyclohexyl group. Tm is higher than in claim 1.

### Technical Problem

In the field of thermoplastic composites based on polyamides, a major challenge is to find an easy to prepare semi-crystalline resin that exhibits a high glass transition temperature (Tg) to allow the polyamide to be used for a wide range of operating temperatures and a low melting temperature (Tm) to facilitate the processing of the polyamide.

Moreover, for the preparation of a thermoplastic composite by melt impregnation, the polyamide used in the preparation of the thermoplastic preferably exhibits a “low” crystallization temperature (Tc) (e.g. Tc<230° C., preferably ≤225° C.) in order to prepare a thermoplastic composite that exhibits lesser stresses and less warpage.

In addition to the afore-mentioned thermal properties, the resin forming the matrix o the composite should exhibit a high elongation at break and resistance to impact. Moreover, sustainable resins are more regularly sought after.

The polyamide of the invention aims at solving this technical problem.

### General Definitions

These definitions apply to the present disclosure.

wt. % is a percentage by weight. Mol.% is a percentage by mole.

Unless otherwise stated, the proportions of recurring units in the polyamide are given in mol % and relative to the total proportion of recurring units in the polyamide.

When numerical ranges are given herein, unless otherwise indicated, the end-points of the ranges (even the open-ended ranges such as those comprising “at least”, “at most”, “lower than”, etc) are included.

In the present application, unless otherwise indicated, any specific embodiment or technical feature relating to one of the subject-matters of the invention is applicable to and interchangeable with another embodiment or technical feature relating also to said subject matter and disclosed elsewhere in the application.

The proportions of diamines in the diamine component (A) are based on the total amount of diamines in the diamine component (A). The proportions of carboxylic diacids in the dicarboxylic acid component (B) are based on the total amount of dicarboxylic acids in the dicarboxylic acid component (B).

The proportions of recurring units in polyamide (PA) are expressed in mol % and are based on the total amount of recurring units in the polyamide (PA).

### BRIEF DISCLOSURE OF THE INVENTION

The invention is set out in the appended set of claims.

The invention relates to a polyamide as disclosed in any one of claims 1-25.

The invention also relates to a thermoplastic composite as defined in claim 26.

The invention also relates to the use as defined in claim 27.

More precisions and details about these subject-matters are now provided below.

### DETAILED DESCRIPTION OF THE INVENTION

The invention relates to a semi-aromatic copolyamide (PA) exhibiting a melting temperature Tm strictly lower than 300° C. (<300° C.), preferably lower than or equal to 296.0° C. (≤296.0° C.), preferably lower than or equal to 295.0° C. (≤295.0° C.), preferably strictly lower than 290° C. (<290° C.), and comprising recurring units formed from the polycondensation of a diamine component (A) and a dicarboxylic acid component (B) wherein:
a) the diamine component (A) comprises:
   between 38.0 and 54.0 mol % of 1,6-diaminohexane;
   between 15.0 and 40.0 mol % of a diamine (D1) selected in the group consisting of 1,9-diaminononane, 1,10-diaminodecane and a combination of said two diamines;
   between 15.0 and 40.0 mol % of a diamine (D2) selected in the group consisting of 1,3-bis(aminomethyl)cyclohexane, 1,4-bis(aminomethyl)cyclohexane and a combination of said two diamines;
   these proportions in mol % being based on the total amount of diamines in the diamine component (A);
b) the dicarboxylic acid component (B) comprises:
   between 95.0 and 100.0 mol % of terephthalic acid;
   between 0 and 5.0 mol % of another diacid (DI) selected in the group consisting of isophthalic acid, adipic acid and a combination of said two diacids;
   these proportions in mol % being based on the total amount of dicarboxylic acids in the dicarboxylic acid component (B).

The polyamide (PA) disclosed in the present invention thus comprises in reacted form the diamines of the diamine component (A) and the dicarboxylic acids of the dicarboxylic acid component (B) with the proportions indicated herein.

The polyamide (PA) of the invention is formed from the polycondensation of the diamine component (A) and the dicarboxylic acid component (B). Therefore, the proportion of —NH₂ from the diamine component (A) and the proportion of —COOH from the dicarboxylic acid component (B) are substantially equimolar. The molar ratio —NH₂ from the diamine component (A)/COOH from the dicarboxylic acid component (B) is preferably comprised between 0.9 to 1.1, preferentially 0.95 to 1.05, even more preferentially between 0.98 to 1.02.

More details about the diamine component (A) and the dicarboxylic acid component (B) are now provided below.

### About the Diamine Component (A)

The diamine component (A) is based on the following diamines: 1,6-diaminohexane (of formula NH₂—(CH₂)₆—NH₂); a diamine (D1) selected in the group consisting of 1,9-diaminononane (of formula NH₂—(CH₂)₉—NH₂), 1,10-diaminodecane (of formula NH₂—(CH₂)₁₀—NH₂) and a combination of said two diamines; and a bis(aminomethyl)cyclohexane (D21).

The proportion of 1,6-diaminohexane is between 38.0 and 54.0 mol %. This proportion may more particularly be between 38.0 and 52.0 mol %. This proportion may more particularly be between 38.0 and 47.0 mol %. This proportion may also be between 42.0 and 47.0 mol % or between 48.0 and 52.0 mol % or between 38.0 and 42.0 mol %.

The diamine component (A) comprises also another diamine (D1) selected in the group consisting of 1,9-diaminononane, 1,10-diaminodecane and a combination of said two diamines. This diamine (D1) may be more particularly 1,9-diaminononane. This diamine (D1) may also be more particularly 1,10-diaminodecane. The proportion of said other diamine(s) (D1) is between 15.0 and 40.0 mol %. This proportion may more particularly be between 18.0 and 40.0 mol %. This proportion may more particularly be between 33.0 and 37.0 mol % or between 18.0 and 22.0 mol % or between 23.0 and 27.0 mol % or between 28.0 and 32.0 mol %.

The diamine component (A) comprises also a bis(aminomethyl)cyclohexane (D2) selected in the group consisting of 1,3-bis(aminomethyl)cyclohexane, 1,4-bis(aminomethyl)cyclohexane and a combination of said two diamines. 1,3-bis(aminomethyl)cyclohexane is the diamine of formula:

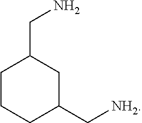

1,4-bis(aminomethyl)cyclohexane is the diamine of formula:

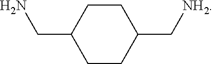

This diamine (D2) may be more particularly 1,3-bis(aminomethyl)cyclohexane. This diamine (D2) may be more particularly 1,4-bis(aminomethyl)cyclohexane. The proportion of said other diamine(s) (D2) is between 15.0 and 40.0 mol %. This proportion may more particularly be between 18.0 and 40.0 mol %. This proportion may more particularly be between 18.0 and 22.0 mol % or between 28.0 and 32.0 mol % or between 33.0 and 37.0 mol %.

According to an embodiment (E1), the proportions in the diamine component (A) are the following ones:
between 42.0 and 47.0 mol % of 1,6-diaminohexane;
between 33.0 and 37.0 mol % of a diamine (D1) selected in the group consisting of 1,9-diaminononane, 1,10-diaminodecane and a combination of said two diamines;
between 18.0 and 22.0 mol % of a diamine (D2) selected in the group consisting of 1,3-bis(aminomethyl)cyclohexane, 1,4-bis(aminomethyl)cyclohexane and a combination of said two diamines;
these proportions in mol % being based on the total amount of diamines in the diamine component (A).

According to another embodiment (E2), the proportions in the diamine component (A) are the following ones:
between 48.0 and 52.0 mol % of 1,6-diaminohexane;
between 18.0 and 22.0 mol % of a diamine (D1) selected in the group consisting of 1,9-diaminononane, 1,10-diaminodecane and a combination of said two diamines;
between 28.0 and 32.0 mol % of a diamine (D2) selected in the group consisting of 1,3-bis(aminomethyl)cyclohexane, 1,4-bis(aminomethyl)cyclohexane and a combination of said two diamines;
these proportions in mol % being based on the total amount of diamines in the diamine component (A).

According to another embodiment (E3), the proportions in the diamine component (A) are the following ones:
between 38.0 and 42.0 mol % of 1,6-diaminohexane;
between 23.0 and 27.0 mol % of a diamine (D1) selected in the group consisting of 1,9-diaminononane, 1,10-diaminodecane and a combination of said two diamines;
between 33.0 and 37.0 mol % of a diamine (D2) selected in the group consisting of 1,3-bis(aminomethyl)cyclohexane, 1,4-bis(aminomethyl)cyclohexane and a combination of said two diamines;
these proportions in mol % being based on the total amount of diamines in the diamine component (A).

According to another embodiment (E4), the proportions in the diamine component (A) are the following ones:
between 48.0 and 52.0 mol % of 1,6-diaminohexane;
between 28.0 and 32.0 mol % of a diamine (D1) selected in the group consisting of 1,9-diaminononane, 1,10-diaminodecane and a combination of said two diamines;
between 18.0 and 22.0 mol % of a diamine (D2) selected in the group consisting of 1,3-bis(aminomethyl)cyclohexane, 1,4-bis(aminomethyl)cyclohexane and a combination of said two diamines;
these proportions in mol % being based on the total amount of diamines in the diamine component (A).

According to another embodiment (E5), the proportions in the diamine component (A) are the following ones:
between 48.0 and 52.0 mol % of 1,6-diaminohexane;
between 18.0 and 22.0 mol % of a diamine (D1) selected in the group consisting of 1,9-diaminononane, 1,10-diaminodecane and a combination of said two diamines;
between 28.0 and 32.0 mol % of a diamine (D2) selected in the group consisting of 1,3-bis(aminomethyl)cyclohexane, 1,4-bis(aminomethyl)cyclohexane and a combination of said two diamines;
these proportions in mol % being based on the total amount of diamines in the diamine component (A).

According to another embodiment (E6), the proportions in the diamine component (A) are the following ones:
between 43.0 and 47.0 mol % of 1,6-diaminohexane;
between 33.0 and 37.0 mol % of a diamine (D1) selected in the group consisting of 1,9-diaminononane, 1,10-diaminodecane and a combination of said two diamines;
between 18.0 and 22.0 mol % of a diamine (D2) selected in the group consisting of 1,3-bis(aminomethyl)cyclohexane, 1,4-bis(aminomethyl)cyclohexane and a combination of said two diamines;
these proportions in mol % being based on the total amount of diamines in the diamine component (A).

All details and embodiments disclosed in the present disclosure are applicable to any one of embodiments (E1)-(E6).

According to an embodiment, the diamine component (A) consists essentially of or consists of 1,6-diaminohexane; the diamine (D1) selected in the group consisting of 1,9-diaminononane, 1,10-diaminodecane and a combination of said two diamines and a diamine (D2) selected in the group consisting of 1,3-bis(aminomethyl)cyclohexane, 1,4-bis(aminomethyl)cyclohexane and a combination of said two diamines with the proportions indicated herein. The expression “consist essentially” means in the context of the invention in relation to the diamine component (A) that the diamine component (A) comprises the indicated diamines and may also comprise up to 2.0 mol %, preferably up to 1.0 mol %, even more preferably up to 0.5 mol %, of at least one additional diamine other than the indicated ones, this proportion in mol % being based on the total amount of diamines in the diamine component (A). Thus, the diamine component (A) consist of 1,6-diaminohexane; a diamine (D1) selected in the group consisting of 1,9-diaminononane, 1,10-diaminodecane and a combination of said two diamines; a diamine (D2) selected in the group consisting of 1,3-bis(aminomethyl)cyclohexane, 1,4-bis(aminomethyl)cyclohexane and a combination of said two diamines and up to 2.0 mol %, preferably up to 1.0 mol %, even more preferably up to 0.5 mol %, of at least one additional diamine other than 1,6-diaminohexane, D1 and D2, this proportion in mol % being based on the total amount of diamines in the diamine component (A).

The diamine component (A) may be based on the following combination of diamines: 1,6-diaminohexane+(1,9-diaminononane or 1,10-diaminodecane)+1,3-bis(aminomethyl)cyclohexane with the proportions indicated herein. According to an embodiment, the diamine component (A) consists essentially of or consists of [1,6-diaminohexane+1,9-diaminononane or 1,10-diaminodecane+1,3-bis(aminomethyl)cyclohexane] where the expression “consist essentially” means that the diamine component (A) consist of 1,6-diaminohexane; 1,9-diaminononane or 1,10-diaminodecane; 1,3-bis(aminomethyl)cyclohexane and up to 2.0 mol %, preferably up to 1.0 mol %, even more preferably up to 0.5 mol %, of at least one additional diamine other than 1,6-diaminohexane; 1,9-diaminononane; 1,10-diaminodecane and 1,3-bis(aminomethyl)cyclohexane, this proportion in mol % being based on the total amount of diamines in the diamine component (A).

The diamine component (A) may be based on the following combination of diamines: 1,6-diaminohexane+(1,9-diaminononane or 1,10-diaminodecane)+1,4-bis(aminomethyl)cyclohexane with the proportions indicated herein. According to an embodiment, the diamine component (A) consists essentially of or consists of [1,6-diaminohexane+1,9-diaminononane or 1,10-diaminodecane+1,4-bis(aminomethyl)cyclohexane] where the expression The expression “consist essentially” means that the diamine component (A) consist of 1,6-diaminohexane; 1,9-diaminononane or 1,10-diaminodecane; 1,4-bis(aminomethyl)cyclohexane and up to 2.0 mol %, preferably up to 1.0 mol %, even more preferably up to 0.5 mol %, of at least one additional diamine other than 1,6-diaminohexane; 1,9-diaminononane; 1,10-diaminodecane and 1,4-bis(aminomethyl)cyclohexane, this proportion in mol % being based on the total amount of diamines in the diamine component (A).

### About the Dicarboxylic Acid Component (B)

The dicarboxylic acid component (B) is based on terephthalic acid as the major component of the dicarboxylic acid component (B). The dicarboxylic acid component (B) may also comprise another diacid (DI) selected in the group consisting of isophthalic acid, adipic acid and a combination of said two diacids.

The dicarboxylic acid component (B) comprises:
between 95.0 and 100.0 mol % of terephthalic acid;
between 0 and 5.0 mol % of another diacid (DI) selected in the group consisting of isophthalic acid, adipic acid and a combination of said two diacids;
these proportions in mol % being based on the total amount of dicarboxylic acids in the dicarboxylic acid component (B).

These proportions may be more particularly the following: between 95.0 and 99.9 mol % of terephthalic acid and between 0.1 and 5.0 mol % of the other diacid(s) (DI).

These proportions may be more particularly the following: between 98.0 and 99.9 mol % of terephthalic acid and between 0.1 and 5.0 mol % of the other diacid(s) (DI).

The diacid (DI) other than terephthalic acid may be more particularly isophthalic acid.

The diacid (DI) other than terephthalic acid may be more particularly adipic acid.

The proportions in the dicarboxylic acid component (B) may more particularly be the following:
between 98.0 and 100.0 mol % of terephthalic acid;
between 0 and 2.0 mol % of another diacid (DI) selected in the group consisting of isophthalic, adipic acid and a combination of said two diacids;
these proportions in mol % being based on the total amount of dicarboxylic acids in the dicarboxylic acid component (B).

These proportions may be more particularly the following: between 98.0 and 99.9 mol % of terephthalic acid and between 0.1 and 2.0 mol % of the other diacid(s) (DI).

According to an embodiment, the dicarboxylic acid component (B) consists essentially of or consists of terephthalic acid and diacid (DI). This expression “consist essentially” means in the context of the invention in relation to the dicarboxylic acid component (B) that the dicarboxylic acid component (B) consists of terephthalic acid, of diacid (DI) and up to 2.0 mol %, preferably up to 1.0 mol %, even more preferably up to 0.5 mol %, of at least one additional diacid other than terephthalic acid and diacid DI, this proportion in mol % being based on the total amount of dicarboxylic acids in the dicarboxylic acid component (B).

The diamine component (A) and the dicarboxylic acid component (B) preferably do not comprise a lactam. The diamine component (A) and the dicarboxylic acid component (B) preferably do not comprise an aminoacid. The diamine component (A) and the dicarboxylic acid component (B) preferably do not comprise isophoronediamine.

Embodiment (E): according to a preferred embodiment (E), the dicarboxylic acid component (B) consists essentially of or consists of terephthalic acid.

The expression “consist essentially” means in the context of the invention in relation to the dicarboxylic acid component (B) that the dicarboxylic acid component (B) comprises terephthalic acid and may also comprise up to 2.0 mol %, preferably up to 1.0 mol %, even more preferably up to 0.5 mol %, of at least one additional diacid other than terephthalic acid, this proportion in mol % being based on the total amount of dicarboxylic acids in the dicarboxylic acid component (B). Thus, the dicarboxylic acid component (B) consists of terephthalic acid and up to 2.0 mol %, preferably up to 1.0 mol %, even more preferably up to 0.5 mol %, of at least one additional diacid other than terephthalic acid, this proportion in mol % being based on the total amount of dicarboxylic acids in the dicarboxylic acid component (B).

All details and embodiments disclosed in the present disclosure are applicable to embodiment (E).

Under embodiment (E), the skilled person understands that the polyamide (PA) can be described as comprising the following recurring units (R_{PA1}), (R_{PA2}) and (R_{PA3}):

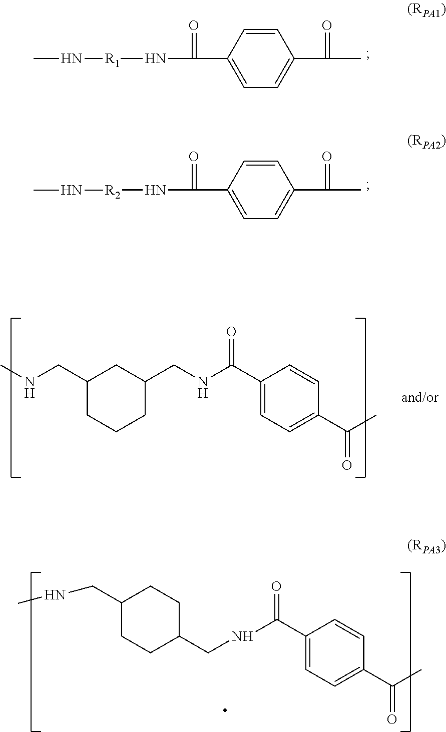

or the following recurring units (R_{PA1}), (R_{PA2}) and (R_{PA3}):

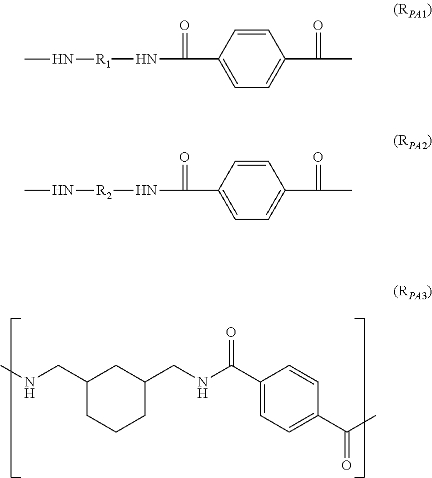

where R₁ is hexamethylene —(CH₂)₆— and R₂ is the divalent radical of a diamine selected in the group consisting of 1,9-diaminononane, 1,10-diaminodecane and a combination of said two diamines. For clarity, the divalent radical of 1,9-diaminononane is —(CH₂)₉— and the divalent radical of 1,10-diaminodecane is —(CH₂)₁₀.

R_{PA1} corresponds to the recurring unit obtained from the reaction of terephthalic acid with 1,6-diaminohexane and R_{PA2} corresponds to the recurring unit obtained from the reaction of terephthalic acid with the other diamine(s) in C9 and/or C10. Likewise, R_{PA3} corresponds to the recurring unit obtained from the reaction of terephthalic acid with the bis(aminomethyl)cyclohexane (e.g. 1,3-bis(aminomethyl)cyclohexane and/or 1,4-bis(aminomethyl)cyclohexane).

All the proportions and embodiments provided herein for the proportions of the diamines 1,6-diaminohexane, D1 and D2 in the diamine component (A) can be translated into respectively proportions of (R_{PA1}), (R_{PA2}) and (R_{PA3}).

The proportions of said recurring units in polyamide (PA) are the following:
R_{PA1}: between 38.0 and 54.0 mol %;
R_{PA2}: between 15.0 and 40.0 mol %;
R_{PA3}: between 15.0 and 40.0 mol %;
these proportions in mol % being relative to the total amount of recurring units in the polyamide (PA).

According to an embodiment, the total proportion of recurring units (R_{PA1}), (R_{PA2}) and (R_{PA3}) in the polyamide (PA) is at least 95.0 mol %, more particularly at least 99.0 mol %.

According to another embodiment, the recurring units of the polyamide (PA) consists essentially of or consist of the recurring units (R_{PA1}), (R_{PA2}) and (R_{PA3}). The expression “consist essentially” in relation to the recurring units of polyamide (PA) means that the recurring units of the polyamide consist of (R_{PA1}), (R_{PA2}) and (R_{PA3}) and up to 2.0 mol %, preferably up to 1.5 mol %, preferably up to 1.0 mol %, preferably up to 0.5 mol % of recurring units other than recurring units (R_{PA1}), (R_{PA2}) and (R_{PA3}).

The proportion of R_{PA1} is between 38.0 and 54.0 mol %. This proportion may more particularly be between 38.0 and 52.0 mol %. This proportion may more particularly be between 38.0 and 47.0 mol %. This proportion may also be between 42.0 and 47.0 mol % or between 48.0 and 52.0 mol % or between 38.0 and 42.0 mol %.

The proportion of R_{PA2} is between 15.0 and 40.0 mol %. This proportion may more particularly be between 18.0 and 40.0 mol %. This proportion may more particularly be between 18.0 and 40.0 mol %. This proportion may more particularly be between 33.0 and 37.0 mol % or between 18.0 and 22.0 mol % or between 23.0 and 27.0 mol % or between 28.0 and 32.0 mol %.

The proportion of R_{PA3} is between 15.0 and 40.0 mol %. This proportion may more particularly be between 18.0 and 40.0 mol %. This proportion may more particularly be between 18.0 and 22.0 mol % or between 28.0 and 32.0 mol % or between 33.0 and 37.0 mol %.

The polyamide (PA) of the invention preferably does not comprise recurring units derived from a lactam or from an aminoacid. The polyamide (PA) of the invention preferably does not comprise recurring units derived from isophoronediamine.

The polyamide (PA) of the invention generally has a number average molecular weight (“Mn”) ranging from 1,000 g/mol to 40,000 g/mol, for example from 2,000 g/mol to 35,000 g/mol, from 4,000 to 30,000 g/mol, or from 5,000 g/mol to 20,000 g/mol. Mn may also be between 8,000 and 20,000 g/mol. Mn is preferably strictly higher than 8,000 g/mol. Mn can be determined by size exclusion chromatography (SEC) with polystyrene standards or by using the following equation (1): Mn=2,000,000/[EG] (1) wherein [EG] is the proportion of end-groups in the polyamide (PA) expressed in mmol/kg. The end-groups in the polyamide (PA) are generally amine and/or acid moieties. Yet, when the polycondensation involves the addition of an end-capping agent, the amine end-groups are converted, partially or totally, into modified end-group(s). For instance, when the end-capping is an acid such as benzoic acid or acetic acid, the remaining amine groups may be totally or partially converted into benzamide or acetamide end groups.

The end-groups in the polyamide (PA) are selected in the group of —NH₂, —COOH and amide end-groups. Indeed, the end-groups in the polyamide (PA) may be —NH₂ or —COOH. Yet, when the polycondensation involves the addition of an end-capping agent, these end-groups may be converted, partially or totally, into amide end-groups.

The amide end groups are of formula —NH—C(═O)—R where R is an alkyl group, an aryl group or a cycloalkyl group and/or of formula —C(═O)—NH—R′ where R′ is an alkyl group or a cycloalkyl group. R is more particularly a linear or branched C₁-C₁₇ alkyl group or a C₅-C₁₀ cycloalkyl group. R′ is more particularly a linear or branched C₂-C₁₈ alkyl group.

The amide end groups of formula —NH—C(═O)—R result from the reaction of the end-groups —NH₂ with a monocarboxylic acid (end-capping agent) of formula R—COOH.

The monocarboxylic acid (end-capping agent) may advantageously be selected in the group consisting of benzoic acid; cyclohexanoic acid; R—COOH where R is a linear or branched C₁-C₁₇ alkyl group and combination of two or more of these acids. R is the radical derived from the acid of formula R—COOH.

The monocarboxylic acid (end-capping agent) may more particularly be selected in the group consisting of acetic acid, propanoic acid, butyric acid, valeric acid, caproic acid, lauric acid, stearic acid, 2-ethylhexanoic acid, cyclohexanoic acid, benzoic acid and combination of two or more of these acids.

The monocarboxylic acid (end-capping agent) is more particularly of formula CH₃—(CH₂)ₙ—COOH where n is an integer between 0 and 16. The amide end groups are then of formula —NH—C(═O)—(CH₂)ₙ—CH₃.

The amide end groups of formula —C(═O)—NH—R′ result from the reaction of the end-groups —COOH with a primary amine (end-capping agent) of formula R′—NH₂.

The primary amine (end-capping agent) may advantageously be selected in the group consisting of the amines of formula R′—NH₂ where R′ is a linear or branched C₂-C₁₈ alkyl group. R′ is the radical derived from the amine of formula R′—NH₂.

The primary amine (end-capping agent) is more particularly of formula CH₃—(CH₂)_{n′}—NH₂ where n′ is an integer between 2 and 18. The amide end groups are then of formula —C(═O)—NH—(CH₂)_{n′}—CH₃.

The primary amine (end capping agent) may more particularly be selected in the group consisting of propyl amine, butylamine, pentylamine, hexylamine, 2-ethylhexylamine, n-octylamine, n-dodecylamine, n-tetradecylamine, n-hexadecylamine, stearylamine, cyclohexylamine and combination of two or more of these amines.

The proportion of the end groups in polyamide (PA) can be quantified by ¹H NMR or by potentiometric techniques.

The polyamide (PA) preferably exhibits an inherent viscosity (“IV”) measured according to ASTM D5336 between 0.5 and 1.5 dL/g, more particularly between 0.7 and 1.3 dL/g, more particularly between 0.75 and 1.20 dL/g. The IV may be between 0.80 and 1.00 dL/g or between 0.90 and 1.20 dL/g. The IV is preferably between 0.95 and 1.20 dL/g. The IV can be measured conveniently in a 60 wt %/40 wt % phenol/tetrachloroethane mixture.

The polyamide (PA) may be prepared from the following combination of monomers as disclosed in Table I or Table III.

### Moisture Absorption

The polyamide (PA) advantageously exhibits a water uptake at 23° C. lower than 5.0 wt %.

The water uptake at 23° C. is determined by (i) providing a specimen shaped according to ISO527 in its dry state (moisture content of less than 0.2 wt. %), (ii) immersing the same in deionized water at 23° C., until reaching a constant weight, (iii) calculating the water uptake with the formula:

$$Water uptake = \frac{{W}_{after} - {W}_{before}}{{W}_{before}} \times 100$$

wherein W_{before} is the weight of the shaped specimen in its original dry state and W_{after} is the weight of the shaped specimen after water uptake.

### Biocontent

Sustainable resins are more and more sought after. This is why polyamide (PA) preferably exhibits a bio content of at least 10.0%, preferably at least 15.0%, the biocontent being expressed as the % of organic carbon of renewable origin determined according to ASTM D6866-22. The bio content of the polyamide (PA) may be at least 20.0%.

The biocontent may be between 10.0 and 21.0%.

The bio content is defined as the % of organic carbon of renewable origin. It corresponds to the amount of C calculated from measured ¹⁴C percent in the sample and corrected for isotopic fraction.

Both the C9 and C10 diamines that are used for the preparation of the polyamide (PA) can be biobased or issued from petroleum or natural gas:

| | 1,9-nonanediamine / 1,9- | 1,10-decanediamine / 1,10- |
|---|---|---|
| | diaminononane (C9) | diaminodecane (C10) |
| | ₂HN—(CH₂)₉—NH₂ | ₂HN—(CH₂)₁₀—NH₂ |
| From petroleum or natural | C9 is traditionally derived | C10 can be prepared from sebacic acid |
| gas (=not biobased) | from petroleum or natural | by the following route: sebacic acid => |
| | gas as it is industrially | sebacic dinitrile => 1,10- |
| | prepared from 1,3-butadiene | decanediamine (C10). Sebacic acid can |
| | by the reductive amination | be produced from adipic acid by an |
| | of 1,9-nonanedial to 1,9- | electrooxidation process developed by |
| | nonanediamine (see U.S. Pat. | Asahi Chemical Industry in Japan |
| | No. 4,510,332 of Kuraray). | (chap. 18.2.3 of Brydson's Plastics |
| | | Materials (Eighth Edition), 2017, isbn |
| | | 978-0-323-35824-8, Prof. |
| | | Marianne Gilbert). See U.S. Pat. No. |
| | | 3,896,011 of Asahi. Adipic acid is |
| | | traditionally derived from petroleum or |
| | | natural gas as it is industrially prepared |
| | | from 1,3-butadiene. |
| Biobased | The biobased 1,9- | Biobased C10 may be prepared from |
| | nonanediamine is generally | sebacic acid derived from castor oil. |
| | derived from oleic acid, a | See Polymers 2016, 8(7), 243 |
| | fatty acid that occurs | (https://doi.org/10.3390/polym8070243) |
| | naturally in various | |
| | resources. Such bio-based | |
| | oleic acid undergoes | |
| | oxidative cleavage to | |
| | produce nonanoic acid and | |
| | azelaic acid, of which the | |
| | latter is subject to nitrilation | |
| | and then hydrogenation to | |
| | obtain 1,9-diaminononane. | |
| | Biobased C9 may be | |
| | prepared according to the | |
| | process disclosed in CN | |
| | 109422656. | |

The polyamide (PA) disclosed herein is therefore preferably prepared from biobased 1,9-nonanediamine (C9) and/or 1,10-decanediamine (C10). This makes it possible to obtain a polyamide (PA) with a high bio content. The high bio content of the PA comes primarily from the C9 and/or C10 diamine.

According to an embodiment, the polyamide (PA) disclosed herein is prepared from biobased 1,9-nonanediamine (C9) and/or 1,10-decanediamine (C10) exhibiting a bio content of at least 99.0%, preferably at least 99.5%, preferably at least 99.9%, the biocontent being expressed as the % of organic carbon of renewable origin measured according to ASTM D6866-22.

However, it is also possible to increase the bio content with the use of a biobased terephthalic acid. A bio based terephthalic acid may for instance be prepared from a biobased furfural as disclosed in Tachibana, Y., Kimura, S. & Kasuya, K.-i. “Synthesis and Verification of Biobased Terephthalic Acid from Furfural” Sci. Rep. 5, 8249; DOI:10.1038/srep08249 (2015). The bio content of polyamide (PA) as defined above may then be at least 65.0%.

### Thermal Properties of the Polyamide (PA)

As noted above, it was surprisingly found that the polyamide (PA) of the invention exhibits a combination of thermal properties. Any feature of the thermal properties disclosed below can be used to characterize the polyamide of the invention.

### 1) Melting Point (Tm)

The polyamide (PA) exhibits a Tm strictly lower than 300° C. (<300° C.), preferably lower than or equal to 296.0° C. (≤296.0° C.), preferably lower than or equal to 295.0° C. (≤296.0° C.), preferably strictly lower than 290° C. (<290° C.).

Tm is preferably lower than or equal to 280° C. (≤280° C.).

Tm may also be lower than or equal to 270° C. (≤270° C.).

The Tm is generally at least 250° C., preferably at least 260° C.

Tm may be between 250° C. and 280° C. or between 260.0 and 280.0° C.

Tm can be measured by Differential Scanning Calorimetry (“DSC”) according to ASTM D3418, notably using a heating and cooling rate of 20° C./min.

Tm can more particularly be measured as described in the experimental section. Indeed, Tm can be measured by Differential Scanning Calorimetry (“DSC”) according to ASTM D3418 using a heating and cooling rate of 20° C./min. Three scans were used for each DSC test: a first heat up to 350° C., followed by a first cool down to 0° C., followed by a second heat up to 360° C. The Tm was determined from the second heat up.

### 2) Glass Transition Temperature (Tg)

The polyamide (PA) exhibits a Tg of at least 140° C., preferably at least 145° C.

The polyamide (PA) generally exhibits a Tg of at most 200° C. or at most 180° C. or at most 160° C.

The Tg may more particularly be between 145° C. and 180° C. or between 145° C. and 160° C.

Tg can be measured by Differential Scanning Calorimetry (“DSC”) according to ASTM D3418, notably using a heating and cooling rate of 20° C./min.

Tg can more particularly be measured as described in the experimental section. Indeed, Tg can be measured by Differential Scanning Calorimetry (“DSC”) according to ASTM D3418 using a heating and cooling rate of 20° C./min. Three scans were used for each DSC test: a first heat up to 350° C., followed by a first cool down to 0° C., followed by a second heat up to 360° C. The Tg was determined from the second heat up.

According to a preferred embodiment, the polyamide (PA) exhibits a difference (Tm−Tg) lower than 130° C., preferably lower than 125° C.

### 3) Crystallization Temperature (Tc)

Polyamide (PA) exhibits a Tc lower than or equal to 225° C., preferably lower than or equal to 220° C.

Tc is generally at least 170° C. or at least 190° C.

Tc may be between 170° C. and 225° C.

Tc is measured by Differential Scanning Calorimetry (“DSC”) according to ASTM D3418, notably using a heating and cooling rate of 20° C./min.

Tc can be measured by Differential Scanning Calorimetry (“DSC”) according to ASTM D3418 using a heating and cooling rate of 20° C./min. Three scans are used for each DSC test: a first heat up to 350° C., followed by a first cool down to 0° C., followed by a second heat up to 360° C. Tc is determined from the first cool down.

The lower the Tc, the better for the preparation of a thermoplastic composite as a lower Tc helps minimize the warpage and the stresses of the resin. The polyamide (PA) of the invention preferably exhibits a difference (Tm−Tc) of at least 50.0° C., preferably of at least 55.0° C., preferably at least 60.0° C. (Tm−Tc) may be between 50.0 and 85.0° C.

### 4) Heat of Fusion (Hm)

The polyamide (PA) is semi-crystalline.

The polyamide (PA) exhibits a Hm of at least 15.0 J/g, preferably at least 20.0 J/g, preferably at least 25.0 J/g, preferably at least 27.0 J/g.

Hm may be at most 40.0 J/g or at most 39.0 J/g.

Hm is preferably between 15.0 and 40.0 J/g, preferably between 15.0 and 40.0 J/g (this latter value being excluded).

Hm can be measured by Differential Scanning Calorimetry (“DSC”) according to ASTM D3418, notably using a heating and cooling rate of 20° C./min.

Hm can more particularly be measured as described in the experimental section. Indeed, Hm can be measured by Differential Scanning Calorimetry (“DSC”) according to ASTM D3418 using a heating and cooling rate of 20° C./min. Three scans were used for each DSC test: a first heat up to 350° C., followed by a first cool down to 0° C., followed by a second heat up to 360° C.

Hm can be measured as described in the experimental section.

### Process of Preparation of Polyamide (PA)

The polyamide (PA) described herein can be prepared by any conventional method adapted to the synthesis of polyamides and polyphthalamides.

The polyamide (PA) is prepared by polycondensation.

The polyamide (PA) can be prepared by heating a reaction mixture (RM) comprising all the monomers that constitute the polyamide (PA) [e.g. 1,6-hexanediamine, D1 and D2, terephthalic acid and optionally DI], preferably in the presence of less than 60 wt. % of water, preferentially less than 30 wt. %, less than 20 wt. %, less than 10 wt. %, preferentially with no added water. This proportion is given based on the total weight of the reaction mixture (RM).

The temperature at which the reaction mixture (RM) is heated must be high enough to induce the reaction between the amine groups and the carboxylic groups and to decrease the viscosity of the reaction mixture. This temperature is generally at least 200° C. The reaction mixture (RM) is preferably heated at a temperature ≥Tm+25° C. The polycondensation results in the formation of the amide bonds and the release of water as a by-product.

The reaction mixture (RM) comprises the diamines of the diamine component (A) and the diacid(s) of the dicarboxylic acid component (B). As detailed above, the proportions of the two components is such that the reaction mixture comprises the monomers in a quantity such that the proportion of —COOH groups from the dicarboxylic acids and the proportion of —NH₂ groups from the diamines are substantially equimolar. The molar ratio —NH₂ from the diamines of the diamine component (A)/—COOH from the dicarboxylic acids of the dicarboxylic acid component (B) is preferably between 0.9 and 1.1, preferentially between 0.95 and 1.05, even more preferentially between 0.98 and 1.02.

The reaction mixture (RM) preferably further comprises a catalyst. The catalyst may be selected in the group consisting of phosphoric acid, phosphorous acid, hypophosphorous acid, phenylphosphonic acid, phenylphosphinic acid, salts of said acids with mono- to trivalent cations and esters of said acids. The cations may for example be Na, K, Mg, Ca, Zn or Al. Examples of esters are triphenyl phosphate, triphenyl phosphite and tris(nonylphenyl) phosphite. A convenient catalyst used is phosphorous acid.

The proportion of the catalyst in the reaction mixture (RM) is preferably between 0.005 and 2.5 wt % based on the weight of the monomers in the reaction mixture.

According to an embodiment of the present disclosure, the reaction mixture (RM) comprises or consists of:
the monomers that constitute the polyamide (PA), as disclosed herein;
optionally a catalyst, notably selected in the group consisting of phosphorous acid, ortho-phosphoric acid, meta-phosphoric acid, alkali-metal hypophosphite, such as sodium hypophosphite and phenylphosphinic acid, and combination thereof;
optionally at least one end-capping agent selected in the group of monocarboxylic acids, primary amines and combination thereof;
water, the proportion of which is less than 60 wt. % of water, preferably less than 30 wt. %, preferably less than 20 wt. %, preferably less than 10 wt. %, this proportion is given based on the total weight of the reaction mixture (RM). According to an embodiment, there is no added water at the beginning of the polycondensation.

For control of the molar mass, it is possible to use at least one chain transfer agent, preferably selected from C₁-C₁₈ monocarboxylic acids and C₃-C₁₈ monoamines. The chain transfer agent may more particularly be selected in the group consisting of acetic acid, propanoic acid, butyric acid, valeric acid, caproic acid, lauric acid, stearic acid, 2-ethylhexanoic acid, cyclohexanoic acid, benzoic acid, butylamine, pentylamine, hexylamine, 2-ethylhexylamine, n-octylamine, n-dodecylamine, n-tetradecylamine, n-hexadecylamine, stearylamine, cyclohexylamine and mixtures thereof.

The polycondensation is advantageously performed in a well-stirred vessel equipped with means to remove the volatile products of the reaction. As the viscosity of the reaction mixture increases over time, the stirrer is adapted to provide sufficient stirring to the reaction mixture (RM) at the beginning of the polymerization and when the conversion of the polycondensation is nearly complete.

The conditions disclosed in the experimental section may conveniently be used for the preparation of the polyamide (PA).

### Thermoplastic Composite (TC)

The polyamide (PA) of the invention is adapted to be used for the preparation of a thermoplastic composite (TC) comprising:
a polymer matrix comprising or consisting of at least one polyamide (PA) and optionally at least one plastic additive; and
fibers.

The proportion of fibers in the thermoplastic composite (TC) is generally at least 40.0 wt %.

The thermoplastic composite (TC) comprises or consists of a polymer matrix and fibers. The fibers are bonded adhesively or cohesively to the matrix, which generally completely surrounds them.

The polymer matrix comprises the polyamide (PA) of the invention and optionally at least one plastic additive, which is blended with the polyamide. The plastic additive may be selected in the group consisting of colorants (e.g., dye and/or pigments), ultraviolet light stabilizers, heat stabilizers, antioxidants, acid scavengers, processing aids, internal lubricants and/or an external lubricants, flame retardants, smoke-suppressing agents, anti-static agents, anti-blocking agents and any combination thereof. The proportion of the plastic additive(s) in the polymer matrix is generally less than 20.0 wt %, this proportion being based on the total weight of the polymer matrix.

The fibers generally exhibit high specific stiffness and strength values.

The fibers can be of inorganic type (e.g. glass fibers) or of organic type (e.g. aramid fibers or carbon fibers). It is also possible to use a combination of various fibers.

The fibers may be selected in the group consisting of glass fibers, carbon fibers, aramid fibers, stainless steel fibers, potassium titanate whiskers and combination of two or more of said fibers.

The thermoplastic composite (TC) can be fabricated by methods well known in the art. In general, regardless of the type of method, composite fabrication includes impregnation of the fibers with the polymer matrix in the molten form, and subsequent cooling to room temperature. The melt impregnation can further include mechanical compression of the melt against the fibers.

The thermoplastic composite (TC) may be used for the preparation of articles for the automotive industry.

### EXPERIMENTAL SECTION

The present examples demonstrate the synthesis, thermal performance, and mechanical performance of the polyamides. The raw materials used to form the samples as provided below:

### Raw Materials Used

The following raw materials were used to prepare the polymer samples:

TABLE I

| Name | Alias | RN CAS | Supplier |
|---|---|---|---|
| biobased 1,10-diaminodecane | DMDA | 646-25-3 | Solvay |
| ₂HN—(CH₂)₁₀—NH₂ | | | (prepared from |
| | | | castor oil) |
| biobased 1,9-diaminononane | NMDA | 646-24-2 | Solvay |
| ₂HN—(CH₂)₉—NH₂ | | | (prepared from |
| | | | oleic acid) |
| 1,6-diaminohexane ₍ₐₖₐ | HMDA | 124-09-4 | Solutia, Inc. |
| _{hexamethylenediamine or} | | | |
| _{1,6-hexanediamine)} | | | |
| ₂HN—(CH₂)₆—NH₂ | | | |
| 1,3- | 1,3-BAC | 2579-20-6 | TCI America |
| cyclohexanebis(methylamine) | | | |
| 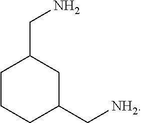 | | | |
| terephthalic acid | TA | 100-21-0 | Flint Hills |
| | | | Resources |
| phosphorus acid | | | Sigma Aldrich |

### Thermal Performance

Tg, Tm and Hm were measured by Differential Scanning Calorimetry (“DSC”) according to ASTM D3418 using a heating and cooling rate of 20° C./min. Three scans were used for each DSC test: a first heat up to 350° C., followed by a first cool down to 0° C., followed by a second heat up to 360° C. The Tg, Tm and Hm were determined from the second heat up. The Tc was determined from the cool down.

### Inherent Viscosity (IV)

The inherent viscosity (IV) is measured according to ASTM D5336 in a mixture 60 wt % phenol-40 wt % tetrachloroethane.

### Tensile Elongation at Break

Measured according to ISO 527 using ISO 1 A bars.

### Chord Modulus and Notched Izod

Chord modulus: measured according to ISO 527 using ISO 1 A bars.
Impact: measured according to ISO 180.

### Biocontent

Determined according to ASTM D6866-22.

### Preparation of the Copolyamides

All of the copolyamides disclosed in Table III were prepared in an autoclave reactor equipped with a distillate line fitted with a pressure control valve.

All copolyamides were prepared by charging into the reactor the monomers with the proportions targeted, water and phosphorous acid and by following the procedure given below in Example 1.

Example 1 (E1): the polyamide E1 was prepared by charging into the reactor 1.77 g of 1,6-diaminohexane, 2.05 g of 1,10-diaminodecane, 0.96 g of 1,3-cyclohexane-bis(methylamine), 5.32 g of terephthalic acid, 4.98 g of deionized water, and 0.0033 g of phosphorous acid. The reactor was sealed, purged with N₂ gas three times. The reactor was heated to 177° C. and held for 30 min, followed by heating to 232° C. and holding for 30 min, followed by heating to 288° C. and holding for 30 min, followed by heating to 343° C. and holding for 35 min. The steam generated was slowly released to keep the internal pressure under 200 psig. Once the temperature was at 343° C. for 35 min, the reactor pressure was slowly reduced to atmospheric pressure over 25 min. After finishing the depressurization, N₂ gas was used to continuously purge the reactor over 25 min. Afterwards, the reactor was cooled to room temperature and the polymer was retrieved from the reactor.

As can be seen with the results of Table III, the specific proportions of the monomers makes it possible to have a balance of properties, notably a high Tg and a low Tm.

Moreover, the polyamide of the invention exhibits significantly high elongation at break and notched impact. It also exhibits improved notched impact.

TABLE II
Mechanical properties

| | Chord Modulus | Tensile elongation | Notched Izod |
|---|---|---|---|
| Ex. | (MPa) | at break (%) | (KJ/m²) |
| E1 | 2620 | 11.0% | 7.5 |
| CE7 | 3080 | 3.9% | 2.5 |

TABLE III

| | | | | | Dicarboxylic | | | | | | | |
|---|---|---|---|---|---|---|---|---|---|---|---|---|
| | Diamine component (A) | | | | acid component | Bio | Thermal properties (obtained by DSC) | | | | | |
| | (proportions in mol %) | | | | (B) (in mol %) | content | (Tg, Tm and Tc in ° C.; Hm in J/g) | | | | | |
| Ex. | HMDA | DMDA | NMDA | 1,3-BAC | TA | (%) | Tg | Tm | Tc | Tm − Tg | Tm − Tc | Hm |
| E1 | 45 | 35 | | 20 | 100 | 22.2 | 149 | 264 | 199 | 115 | 65 | 30.5 |
| E2 | 50 | 20 | | 30 | 100 | 13.0 | 151 | 295 | 220 | 124 | 75 | 41.0 |
| E3 | 40 | 25 | | 35 | 100 | 15.9 | 151 | 263 | | 112 | | 25.1 |
| E4 | 50 | 30 | | 20 | 100 | 19.2 | 155 | 277 | 219 | 122 | 58 | 38.0 |
| E5 | 50 | | 20 | 30 | 100 | 11.8 | 155 | 272 | 217 | 117 | 55 | 37.3 |
| E6 | 45 | | 35 | 20 | 100 | 20.4 | 144 | 292 | 212 | 148 | 80 | 42.0 |
| CE1 | 55 | 25 | | 20 | 100 | 16.2 | 145 | 308 | 242 | 163 | 66 | 39.5 |
| CE2 | 100 | | | | 100 | 0.0 | 115 | 318 | | 203 | | 85 |
| CE3 | | 100 | | | 100 | 55.6 | 119 | 319 | 285 | 200 | 34 | 83 |
| CE4 | | | | 100 | 100 | 0.0 | 182 | 337 | 264 | 155 | 73 | 75 |
| CE5 | 35 | 45 | | 20 | 100 | 27.8 | 137 | 276 | 200 | 139 | 76 | 41 |
| CE6 | 55 | 20 | | 25 | 100 | 13.1 | 150 | 306 | 242 | 156 | 64 | 45 |
| CE7 | | 45 | | 55 | 100 | 26.6 | 150 | 283 | 237 | 133 | 46 | 29 |

1. A polyamide (PA) exhibiting a melting temperature Tm lower than 300° C. (<300° C.), and comprising recurring units formed from the polycondensation of a diamine component (A) and a dicarboxylic acid component (B) wherein:
a) the diamine component (A) comprises:
between 38.0 and 54.0 mol % of 1,6-diaminohexane;
between 15.0 and 40.0 mol % of a diamine (D1) selected from the group consisting of 1,9-diaminononane, 1,10-diaminodecane and a combination of said two diamines;
between 15.0 and 40.0 mol % of a diamine (D2) selected from the group consisting of 1,3-bis(aminomethyl)cyclohexane, 1,4-bis(aminomethyl)cyclohexane and a combination of said two diamines;
these proportions in mol % being based on the total amount of diamines in the diamine component (A);
b) the dicarboxylic acid component (B) comprises:
between 95.0 and 100.0 mol % of terephthalic acid;
between 0 and 5.0 mol % of another diacid selected from the group consisting of isophthalic acid, adipic acid and a combination of the two said diacids;
these proportions in mol % being based on the total amount of diacids in the dicarboxylic acid component (B);
Tm being measured by DSC according to ASTM D3418, using a heating and cooling rate of 20° C./min.

2. The Polyamide (PA) according to claim 1, wherein the diamine component (A) consists essentially of 1,6-diaminohexane; a diamine (D1) selected from the group consisting of 1,9-diaminononane, 1,10-diaminodecane and a combination of said two diamines and a diamine (D2) selected from the group consisting of 1,3-bis(aminomethyl)cyclohexane, 1,4-bis(aminomethyl)cyclohexane and a combination of said two diamines, the expression “consist essentially of” meaning that the diamine component (A) consist of 1,6-diaminohexane, of D1 and of D2 and up to 2.0 mol % of at least one additional diamine other than 1,6-diaminohexane, of D1 and of D2, this proportion in mol % being based on the total amount of diamines in the diamine component (A), and/or wherein the dicarboxylic acid component (B) consists essentially of terephthalic acid and the other diacid(s) (DI), the expression “consist essentially” meaning that the dicarboxylic acid component (B) consists of terephthalic acid, of diacid (DI) and up to 2.0 mol % of at least one additional diacid other than terephthalic acid and diacid(s) (DI), this proportion in mol % being based on the total amount of dicarboxylic acids in the dicarboxylic acid component (B).

3. (canceled)

4. The Polyamide according to claim 1, wherein the dicarboxylic acid component (B) consists essentially of terephthalic acid, the expression “consist essentially” meaning that the dicarboxylic acid component (B) consists of terephthalic acid and up to 2.0 mol % of at least one additional diacid other than terephthalic acid, this proportion in mol % being based on the total amount of dicarboxylic acids in the dicarboxylic acid component (B).

5. The Polyamide (PA) according to claim 1, wherein the proportions in the dicarboxylic acid component (B) are the following ones:
between 95.0 and 99.9 mol % of terephthalic acid and between 0.1 and 5.0 mol % of the other diacid(s); or
between 98.0 and 99.9 mol % of terephthalic acid and between 0.1 and 2.0 mol % of the other diacid(s).

6. The Polyamide (PA), according to claim 1, comprising the recurring units (R_{PA1}), (R_{PA2}) and (R_{PA3}): 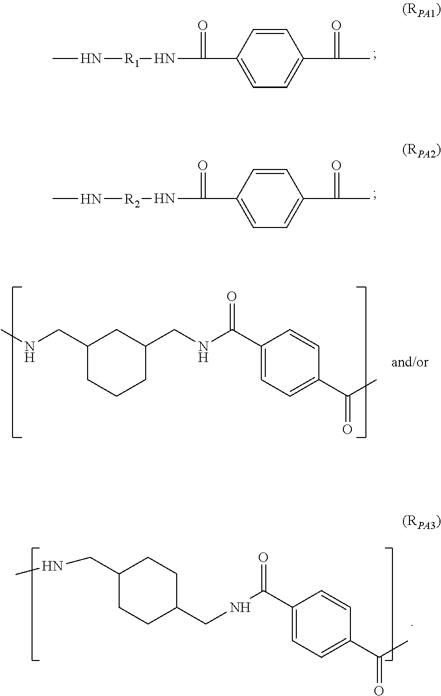
or the following ones: 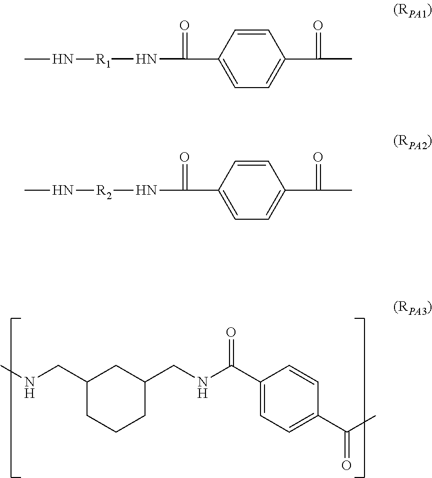
where R₁ is —(CH₂)₆— and R₂ is the divalent radical of a diamine selected from the group consisting of 1,9-diaminononane, 1,10-diaminodecane and a combination of said two diamines;
the proportions in said recurring units being the following:
R_{PA1}: between 38.0 and 54.0 mol %;
R_{PA2}: between 15.0 and 40.0 mol %;
R_{PA3}: between 15.0 and 40.0 mol %;
these proportions in mol % being relative to the total amount of recurring units in the polyamide (PA);
wherein the total proportion of recurring units (R_{PA1}), (R_{PA2}) and (R_{PA3}) is at least 95.0 mol %.

7. (canceled)

8. (canceled)

9. The Polyamide (PA) according to claim 1, wherein the proportion of 1,6-hexanediamine in the diamine component (A) or the proportion of R_{PA1} in the polyamide (PA) is:
between 38.0 and 52.0 mol %; or
between 38.0 and 47.0 mol %; or
between 42.0 and 47.0 mol %; or
between 48.0 and 52.0 mol %; or
between 38.0 and 42.0 mol %.

10. The Polyamide (PA) according to claim 1, wherein the proportion in the diamine component (A) of the other diamine (D1) selected from the group consisting of 1,9-diaminononane, 1,10-diaminodecane and a combination of said two diamines or the proportion of R_{PA2} in the polyamide (PA) is:
between 18.0 and 33.0 mol %; or
between 18.0 and 40.0 mol %; or
between 33.0 and 37.0 mol %; or
between 18.0 and 22.0 mol %; or
between 23.0 and 27.0 mol %; or
between 28.0 and 32.0 mol %.

11. The Polyamide (PA) according to claim 1, wherein the proportion in the diamine component (A) of the other diamine (D2) selected from the group consisting of 1,3-bis(aminomethyl)cyclohexane, 1,4-bis(aminomethyl)cyclohexane and a combination of said two diamines or the proportion of R_{PA3} in the polyamide (PA) is:
between 18.0 and 40.0 mol %; or
between 18.0 and 22.0 mol %; or
between 28.0 and 32.0 mol %; or
between 33.0 and 37.0 mol %.

12. The Polyamide (PA) according to claim 1, wherein the proportions in the diamine component (A) are the following ones:
between 42.0 and 47.0 mol % of 1,6-diaminohexane;
between 33.0 and 37.0 mol % of a diamine (D1) selected from the group consisting of 1,9-diaminononane, 1,10-diaminodecane and a combination of said two diamines;
between 18.0 and 22.0 mol % of a diamine (D2) selected from the group consisting of 1,3-bis(aminomethyl)cyclohexane, 1,4-bis(aminomethyl)cyclohexane and a combination of said two diamines;
or the following ones:
between 48.0 and 52.0 mol % of 1,6-diaminohexane;
between 18.0 and 22.0 mol % of a diamine (D1) selected from the group consisting of 1,9-diaminononane, 1,10-diaminodecane and a combination of said two diamines;
between 28.0 and 32.0 mol % of a diamine (D2) selected from the group consisting of 1,3-bis(aminomethyl)cyclohexane, 1,4-bis(aminomethyl)cyclohexane and a combination of said two diamines;
or the following ones:
between 38.0 and 42.0 mol % of 1,6-diaminohexane;
between 23.0 and 27.0 mol % of a diamine (D1) selected from the group consisting of 1,9-diaminononane, 1,10-diaminodecane and a combination of said two diamines;
between 33.0 and 37.0 mol % of a diamine (D2) selected from the group consisting of 1,3-bis(aminomethyl)cyclohexane, 1,4-bis(aminomethyl)cyclohexane and a combination of said two diamines;
or the following ones:
between 48.0 and 52.0 mol % of 1,6-diaminohexane;
between 28.0 and 32.0 mol % of a diamine (D1) selected from the group consisting of 1,9-diaminononane, 1,10-diaminodecane and a combination of said two diamines;
between 18.0 and 22.0 mol % of a diamine (D2) selected from the group consisting of 1,3-bis(aminomethyl)cyclohexane, 1,4-bis(aminomethyl)cyclohexane and a combination of said two diamines;
or the following ones:
between 48.0 and 52.0 mol % of 1,6-diaminohexane;
between 18.0 and 22.0 mol % of a diamine (D1) selected from the group consisting of 1,9-diaminononane, 1,10-diaminodecane and a combination of said two diamines;
between 28.0 and 32.0 mol % of a diamine (D2) selected from the group consisting of 1,3-bis(aminomethyl)cyclohexane, 1,4-bis(aminomethyl)cyclohexane and a combination of said two diamines;
or the following ones:
between 43.0 and 47.0 mol % of 1,6-diaminohexane;
between 33.0 and 37.0 mol % of a diamine (D1) selected from the group consisting of 1,9-diaminononane, 1,10-diaminodecane and a combination of said two diamines;
between 18.0 and 22.0 mol % of a diamine (D2) selected from the group consisting of 1,3-bis(aminomethyl)cyclohexane, 1,4-bis(aminomethyl)cyclohexane and a combination of said two diamines.

13. The Polyamide (PA) according to claim 6, wherein the proportions are the following ones:
between 42.0 and 47.0 mol % of R_{PA1};
between 33.0 and 37.0 mol % of R_{PA2};
between 18.0 and 22.0 mol % of R_{PA3}.
or the following ones:
between 48.0 and 52.0 mol % of R_{PA1};
between 18.0 and 22.0 mol % of R_{PA2};
between 28.0 and 32.0 mol % of R_{PA3};
or the following ones:
between 38.0 and 42.0 mol % of R_{PA1};
between 23.0 and 27.0 mol % of R_{PA2};
between 33.0 and 37.0 mol % of R_{PA3};
or the following ones:
between 48.0 and 52.0 mol % of R_{PA1};
between 28.0 and 32.0 mol % of R_{PA2};
between 18.0 and 22.0 mol % of R_{PA3};
or the following ones:
between 48.0 and 52.0 mol % of R_{PA1};
between 18.0 and 22.0 mol % of R_{PA2};
between 28.0 and 32.0 mol % of R_{PA3};
or the following ones:
between 43.0 and 47.0 mol % of R_{PA1};
between 33.0 and 37.0 mol % of R_{PA2};
between 18.0 and 22.0 mol % of R_{PA3};
these proportions being given relative to the total proportions of recurring units in the polyamide (PA).

14. (canceled)

15. (canceled)

16. The Polyamide (PA) according to claim 1, wherein the melting temperature Tm of the polyamide (PA) is:
lower than or equal to 280° C.; and/or
at least 250° C.;
Tm being measured by DSC according to ASTM D3418, using a heating and cooling rate of 20° C./min.

17. The Polyamide (PA) according to claim 1, wherein the glass transition temperature Tg of the polyamide (PA) is:
at least 140° C.; and/or
at most 200° C.;
Tg being measured by DSC according to ASTM D3418, using a heating and cooling rate of 20° C./min.

18. The Polyamide (PA) according to claim 1, exhibiting a difference (Tm−Tg) lower than 130° C., the melting temperature Tm and the glass transition temperature Tg being measured by DSC according to ASTM D3418, using a heating and cooling rate of 20° C./min; and/or exhibiting a difference (Tm−Tc) of at least 50.0° C. the melting temperature Tm and the crystallization temperature Tc being measured by DSC according to ASTM D3418, using a heating and cooling rate of 20° C./min.

19. (canceled)

20. The Polyamide (PA) according to claim 1, exhibiting a heat of fusion Hm:
of at least 15.0 J/g; and/or
between 15.0 and 40.0 J/g;
Hm being be measured by Differential Scanning Calorimetry (“DSC”) according to ASTM D3418, using a heating and cooling rate of 20° C./min.

21. The Polyamide (PA) according to claim 1, exhibiting an inherent viscosity (“IV”) measured according to ASTM D5336 is:
between 0.5 and 1.5 dL/g; or
between 0.7 and 1.3 dL/g; or
between 0.75 and 1.20 dL/g; or
between 0.80 and 1.00 dL/g; or
between 0.90 and 1.20 dL/g; or
between 0.95 and 1.20 dL/g.

22. (canceled)

23. The Polyamide (PA) according to claim 1, exhibiting a bio content of at least 10.0%, the biocontent being expressed as the % of organic carbon of renewable origin determined according to ASTM D6866-22, the bio content being defined as the % of organic carbon of renewable origin and corresponding to the amount of C calculated from measured ¹⁴C percent and corrected for isotopic fraction.

24. (canceled)

25. The Polyamide (PA) according to claim 1, prepared by polycondensation by heating a reaction mixture (RM) comprising all the monomers, the reaction mixture (RM) comprising:
the monomers that constitute the polyamide (PA);
optionally a catalyst, selected from the group consisting of phosphorous acid, ortho-phosphoric acid, meta-phosphoric acid, alkali-metal hypophosphite, and combination thereof;
optionally at least one end-capping agent selected from the group of monocarboxylic acids, primary amines and combination thereof;
water, the proportion of which is less than 60 wt. %, this proportion is given based on the total weight of the reaction mixture (RM).

26. A Thermoplastic composite (TC) comprising:
a polymer matrix comprising the polyamide (PA) according to claim 1, and optionally at least one plastic additive, selected from the group consisting of colorants, ultraviolet light stabilizers, heat stabilizers, antioxidants, acid scavengers, processing aids, internal lubricants and/or an external lubricants, flame retardants, smoke-suppressing agents, anti-static agents, anti-blocking agents and any combination thereof; and
fibers.

27. A method of preparing a thermoplastic composite, the method comprising using the polyamide (PA) according to claim 1.
